(19) United States
(12) Patent Application Publication
(10) Pub. No.: US 2006/0091009 A1
(43) Pub. Date: May 4, 2006

(54) Ion selective electrode with integral sealing surface

(76) Inventor: John N. Harman III, Placentia, CA (US)

Correspondence Address: Russell E. Fowler II;Maginot, Moore & Beck LLP, Bank One Center/Tower, 111 Monument Circle, Suite 3000, Indianapolis, IN, 46204-5115, US

(21) Appl. No.: 10/979,507

(22) Filed: Nov. 2, 2004

(51) Int. Cl. G01N 27/26

(52) U.S. Cl. 204/416; 205/775

(57) ABSTRACT

An ion selective electrode assembly (10) comprises an ion selective electrode (12) provided as a solid pellet of polycrystalline electrolyte material with inert conductive and polymeric binding agent additives. The ion selective electrode (12) includes a first face (40), a second face (50), and at least one sidewall (60). An integral sealing surface (30) is electrolytically formed on the sidewall of the ion selective electrode (12). The integral sealing surface (30) may also be formed on a portion of the second face (50) of the ion selective electrode (12). The assembly (10) further comprises a housing (20) for receiving the ion selective electrode. An adhesive (14) is positioned between the integral sealing surface (30) and the housing (20). The adhesive (14) bonds the ion selective electrode to the housing.

### BACKGROUND

This invention relates to the field of electrochemistry, and particularly to ion selective electrodes.

Ion selective electrodes (ISE's) have widespread applications in the fields of biology, chemistry, and medicine. These electrodes provide a useful analytical technique for detecting and measuring the concentration of a particular ionic species in solution. The applications of ISE's are numerous, including biomedical research, clinical testing, industrial pollution testing, and chemical process control.

In clinical medicine, ISE's are important in the diagnosis and treatment of diseases due to their ability to measure ion concentrations or activities in blood, serum, plasma, cerebro spinal fluid, and urine samples. Ions commonly measured in clinical testing include cations and anions. For example, chloride ion levels in bodily fluids are characteristic of certain electrolyte and metabolic disorders including cystic fibrosis, the most common serious genetic disorder in the United States. Similarly, measurements of calcium ion concentration levels are used in the diagnosis of endocrine and renal diseases and in monitoring diseases like cancer. Therefore, it is important that ion concentrations or activities be accurately measured.

Electrolyte analyzers have been developed based on ion-selective electrode technology. In such analyzers, an ISE and an external reference electrode pair are immersed simultaneously in a sample solution. An electrical potential is developed between the electrodes, due to the presence of the ion to which the ISE is sensitive. By measuring this potential, the concentration of the ion can be determined.

Early designs of ISE assemblies comprised an ion selective membrane affixed to the lower opening of a plastic electrode body. The electrode body included an inner electrolyte solution and a reversible internal reference electrode sealed within. This design had several disadvantages including low durability and low reproducibility and the possibility of loss of response to ion concentration or activity changes due to ionically conductive short circuiting paths bypassing the ion selective membrane.

In more recent designs, solid state ion selective electrode assemblies have been developed which utilize a solid-state ion selective electrode in the form of a pellet of compressed polycrystalline material mixture. These solid state ion selective electrode assemblies eliminate the inner electrolyte solution found in earlier designs and provide an electrical conductor that is attached to or embedded in the solid ion selective electrode. The ion selective electrode includes a first side intended for exposure to a test solution and a second side that is connected to the electrical conductor. An electrode body/housing is provided for retaining the ion selective electrode. In particular, the housing is designed to retain the electrode such that the first side is exposed to the exterior of the housing while the second side is concealed within the interior of the housing and shielded from the exterior of the housing. The electrode is secured to the housing using an epoxy or other adhesive.

The system used to mount the electrode to the housing preferably secures the electrode in the housing as well as isolates the second side of the electrode and the electrical conductor from the test solution when the electrode is immersed in the test solution. Unfortunately, problems exist with current mounting systems used to secure the electrode in the housing. For example, the adhesives used to secure the electrode to the housing tend to degrade over time as a result of contact with the test solution. In addition, small voids or bubbles are typically formed at the interface between the electrode and the adhesive or the interface between the adhesive and the housing. These problems can result in reduced electrode sensitivity and inaccurate electrode readings as a result of intrusion of the test solution into the interior of the housing where the second side of the pellet and the electrical conductor are located. In addition, these problems can result in retention of test solutions in the electrode that are not representative of a current test solution.

In an attempt to alleviate the problems encountered with current mounting systems for ion selective electrodes, silicone oil is impregnated in the completed electrode assembly after the pellet is epoxied or otherwise secured within the receiving housing. Vacuum impregnation of the electrode assembly forces silicone oil into any imperfections in the pellet and the mounting system. For example, vacuum impregnation draws silicone oil into any porosities in the epoxy between the pellet and the housing. The silicone oil acts as a repellent agent to block liquid transport through pores or imperfections in the adhesive, including imperfections at the housing/adhesive interface and/or at the adhesive/pellet interface. However, it has been noted that the process of silicone oil impregnation is only variably effective in blocking liquid transport through the housing/adhesive interface and/or the adhesive/pellet interface. Manufacturers of ion selective electrode assemblies encounter highly variable first pass failure rates for ion selective electrode assemblies. Furthermore, the life expectancies for selective ion electrode assemblies are highly variable, as the impregnated silicone oil may be washed out over time by end users of the assemblies as a result of continued exposure to aggressive aqueous environments. Accordingly, there is a need for an improved mounting system for ion selective electrode assemblies that is less dependent on the use of silicone oil to block liquid transport between the housing/adhesive interface and/or the adhesive/pellet interface.

Additional problems also exist with current mounting systems used to secure the ion selective electrode in the housing. For example, it has been observed that ion concentration measurements for a single sample solution are dependent upon different epoxies used with the ion selective electrode. This means that there tends to be an interaction between the epoxy system chemistry and the detection chemistry of the ion selective electrode. Therefore, it would be desirable to provide an impervious barrier between the ion selective electrode and the epoxy to reduce the tendency for the epoxy to have an influence on the ion selective electrode.

Another problem with current mounting systems for electrodes of this type is weakness in the physical adhesion between the ion selective pellet and the electrode housing. This weakness can occur for numerous reasons, including shrinkage of the epoxy during curing and degradation of the epoxy over time and exposure to test solutions. Weak physical adhesion between the ion selective pellet and the electrode housing can reduce electrode sensitivity and alter the actual membrane potential by providing a parallel electrical leakage path resulting in inaccurate ion measurements. Strong physical adhesion between the ion selective pellet and the electrode housing requires strong physical adhesion at the housing/adhesive interface as well as the adhesive/pellet interface. Tests have indicated that the most likely source of weak physical adhesion between the ion selective pellet and the electrode housing is the adhesive/pellet interface, as opposed to the housing/adhesive interface. Accordingly, there is a need for an improved mounting system for ion selective electrodes that provides for a stronger bond between the ion selective pellet and the electrode housing. In particular, there is a need for an ion selective electrode that provides for a stronger bond at the adhesive/pellet interface.

### SUMMARY OF THE INVENTION

An ion selective electrode assembly comprises an ion selective electrode in the form of a solid pellet. The ion selective electrode typically comprises an insoluble metal salt such as silver chloride or a mixture of silver chloride, polymeric binding agents and inert electrically conductive materials. The electrode includes a first face, a second face, and at least one sidewall. A conductor is embedded in the ion selective electrode and extends from the second face of the electrode. An integral sealing surface is electrolytically formed by cathodic reduction on the periphery/sidewall of the ion selective electrode by placing the electrode in an electrolyte and causing current to flow between an anodic counter electrode and the ion selective electrode. The electrolytically formed integral sealing surface is comprised of a metal of the metal salt in the electrode.

A housing is provided for receiving the ion selective electrode and integral sealing surface. The housing includes a seat that receives the ion selective electrode such that the first face of the ion selective electrode is exposed to an exterior of the housing and the second face of the ion selective electrode is exposed to an interior of the housing. An adhesive such as an epoxy is provided between the integral sealing surface and the housing. In one embodiment, the seat of the housing comprises a substantially cylindrical passage and the at least one sidewall of the ion selective electrode is connected to the substantially cylindrical passage by the adhesive. The housing is provided as part of an electrolyte analyzer such that the concentration or activity of ions in a test solution can be determined using the ion selective electrode.

Manufacture of the ion selective electrode assembly includes production of the ion selective electrode. The ion selective electrode is a relatively homogenous mixture of a solid electrolyte composition possessing ionic conductivity and polyvinyl chloride or other suitable polymeric material functioning as a binding agent. In one embodiment, the ion selective electrode is a hybrid of a solid electrolyte composition without polyvinyl chloride joined to a solid electrolyte composition mixed with polyvinyl chloride. The electrode pellet is molded with the electrical conductor extending from the second face of the electrode. After formation of the electrode pellet, the first face of the pellet is masked to prevent reactions from occurring on the masked portion of the pellet during electrolysis. In one embodiment, an annular portion of the second face of the pellet is also masked. The electrode is then immersed in an electrolyte solution along with a counter electrode. An electrical current is directed to flow between the electrode pellet and the counter electrode as they are immersed in the electrolyte solution. As the electrode pellet is subjected to cathodic electrolysis, the integral sealing surface is formed on the periphery/unmasked portions of the electrode by an electrochemical reduction process. After formation of the integral sealing surface, the electrode is placed in the housing such that the integral sealing surface is positioned against the housing seat. The first face of the ion selective electrode is exposed to the exterior of the housing when the electrode is seated in the housing. The second face of the electrode is concealed within the housing. After the electrode is seated in the housing, an epoxy is applied over the first face of the electrode. The epoxy is of a sufficient consistency to flow into the crevice between the housing seat and the integral sealing surface of the ion selective electrode. The epoxy also forms a bead over the first portion of the ion selective electrode. After the epoxy cures, the epoxy bead and some portion of the electrode are machined down to provide a flat surface that extends from housing to epoxy to electrode. The flat surface includes the first face of the electrode exposed to the exterior of the housing.

### BRIEF DESCRIPTION OF DRAWINGS

These and other features, aspects and advantages of the ion selective electrode assembly described herein will become better understood with reference to the following description, appended claims, and accompanying drawings, where:

FIG. 1 shows an ion selective electrode assembly including an electrode with an integral sealing surface;

FIG. 2A shows an electrode for use in the ion selective electrode assembly of FIG. 1 before the electrode is subjected to electrolysis;

FIG. 2B shows the electrode of FIG. 2A after the electrode is subjected to electrolysis;

FIG. 2C shows the electrode of FIG. 2A after the electrode is subjected to electrolysis using an alternative masking procedure;

FIG. 3 shows the electrode of FIG. 2B placed in a housing with epoxy covering the electrode;

FIG. 4 shows the electrode of FIG. 3 following machining of the epoxy;

FIG. 5 shows a flow chart of manufacturing steps for the ion selective electrode assembly of FIG. 1; and

FIG. 6 shows a diagram of a clinical analyzer including the ion selective electrode assembly of FIG. 1.

### DESCRIPTION OF THE BEST MODE OF THE INVENTION

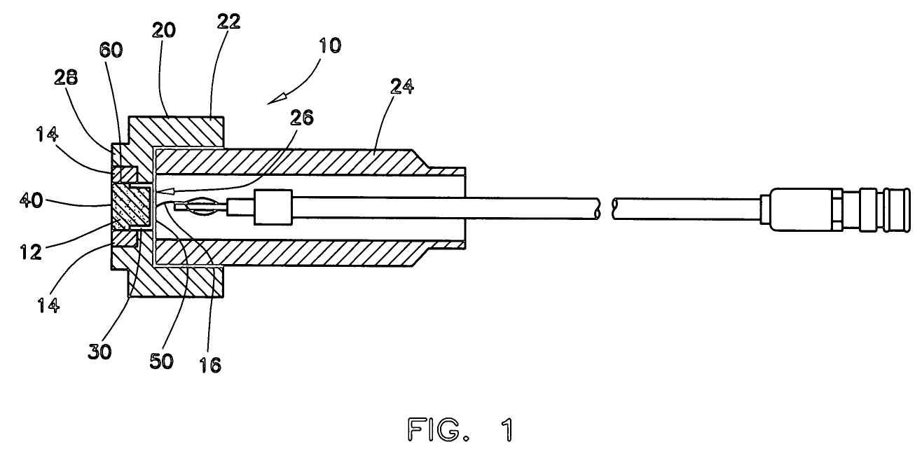

With reference to FIG. 1, one embodiment of the present invention is shown, including an ion selective electrode assembly 10. The assembly 10 comprises a sensor 12 in the form of an ion selective electrode and an electrode housing 20. The electrode 12 is retained within the housing 20 by an adhesive 14. An electrolytically formed integral sealing surface 30 is formed upon the electrode 12. An electrical conductor 16 extends from the electrode 12 within the housing 20. The electrical conductor 16 is joined to a cable 18 that extends from the housing 20.

The housing 20 includes a head portion 22 and an elongated hollow cylindrical tube 24. The head portion 22 includes a substantially cylindrical passage 26 in the form of a central bore designed to receive the electrode 12 and act as a seat for the electrode. An enlarged rim 28 encircles the outer portion of the central bore 26 and forms a countersink in the head portion 22 that is filled with adhesive 14. The elongated tube 24 fits in the mouth of the head portion 22. The housing 20 provides for protection of the electrode 12 and conductor 16 as well as convenience of use and handling. The housing 20 is made of any suitable material that is substantially chemically inert to the sample solution being tested. For example, a plastic, such as polyvinyl chloride, glass, or a ceramic can be used. Other suitable materials are known to those skilled in the art. The housing 20 is of suitable length and diameter for insertion into a sample solution from about 0.1 mL to about 10 mL. In one embodiment, the housing is about 1.4 cm in diameter and about 3 cm in length.

The ion selective electrode 12 is provided in the form of a solid pellet. The electrode 12 includes a first face 40 exposed to the exterior of the housing 20 and an opposite second face 50 concealed within the interior of the housing 20. A cylindrical sidewall 60 is formed around the electrode between the first face 40 and second face 50. The sidewall 60 of the electrode 12 has a diameter which fits snugly within the center bore 26 of the housing 20. When the electrode 12 is seated within the center bore 26 of the housing 20, a portion of the electrode extends past the bore and is exposed to the rim 28 of the head portion 22. The first exposed face 40 of the electrode 12 is positioned within the housing 20 such that the peripheral surface of the first face 40 is parallel with the outermost edge of the rim 28. An adhesive in the form of an epoxy 14 is provided in the countersink between the rim 28 and the portion of the electrode 12 that extends past the bore 26. The epoxy 14 is provided to secure the electrode 12 in the housing as well as form a seal between the electrode 12 and the housing 20.

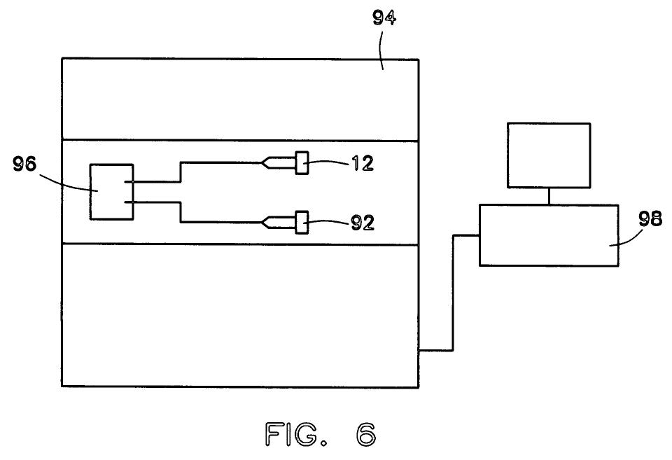

The positioning of the electrode 12 in the housing 20 allows for a substantial portion of the first face 40 to be exposed to the exterior of the housing for direct contact with a sample/test solution 60. The first face 40 is relatively flat and planar for contact with the sample solution 60. The second face 50 is also relatively flat and planar. The electrical conductor 16 is placed half-way inside the pellet and extends from the second face 50. The electrical conductor 16 provides for contact between the electrode 12 and a reference source such as a reference electrode. The electrical conductor 16 may be a wire and comprise any electronic conductive material. The wire is typically is selected from the group consisting of silver, copper, or gold. The electrical conductor 16 is connected to one end of the cable 18. The opposite end of the cable 18 leads to the reference electrode. As shown in FIG. 6, the reference electrode 92 may be provided along with the electrode assembly 12 as part of a clinical analysis system 94 which includes an electrolyte analyzer 96. Such clinical analysis systems also typically include a number of testing devices and/or stations as well as user interface 98, such as a system computer. An example of such a clinical analyzer system is the Synchron® CX5 Delta sold by Beckman Coulter, Inc. of Fullerton, Calif.

The electrode 12 is typically a solid pellet of compressed uniform polycrystalline material comprised of a solid electrolyte composition. In one embodiment, the electrode 12 is formed of a relatively homogeneous mixture which comprises (i) a solid electrolyte composition and (ii) polyvinyl chloride. The solid electrolyte composition typically comprises an insoluble metal salt. The electrolyte composition possesses ionic conductivity and is selective towards a specific ion in a test solution. The ion can be a cation or an anion. The electrolyte composition is chosen according to the ion intended to be measured. The composition can be selective towards a variety of ions including, for example, chloride ions (Cl⁻), bromide ions (Br⁻), iodide ions (I⁻), sulfide ions (S⁻²), copper ions (Cu⁺²), cadmium ions (Cd⁺²), mercuric ions (Hg⁺²), and silver ions (Ag⁺). Table 1 lists some exemplary ions to be detected and an electrolyte composition for detecting the ion.

TABLE I

| IONS | |
|---|---|
| TO BE DETECTED | ELECTROLYTE COMPOSITIONS |
| Cl⁻ | silver chloride (AgCl) |
| Br⁻ | silver bromide (AgBr) |
| I⁻ | silver iodide (AgI) |
| S⁻² | silver sulfide (Ag₂S) |
| Cu⁻² | copper sulfide (CuS) |
| Cd⁺² | cadmium sulfide (CdS) |
| Hg⁺² | mercuric sulfide (HgS) |
| Ag⁺ | silver chloride (AgCl) |

The solid electrolyte composition is preferably particulate in form having a particle size capable of maintaining a relatively uniform homogeneous composition when mixed with polyvinyl chloride or other suitable polymeric binding agent. An exemplary particle size is from about 40 μm to about 100 μm. When silver chloride is chosen for the composition, one exemplary particle size is about 60 μm.

Polyvinyl chloride (PVC) is a plastic added to the electrolyte composition to maintain the hydrophobicity of the electrode 12. Preferably, high molecular weight PVC is used. In one embodiment, the molecular weight is 100,000 daltons (weight average). In another embodiment, the PVC is replaced by another polymer, such as, but not limited to, silicone rubber, Teflon, a polyacrylate polymer, cellulose acetate or any other polymer known to the art.

In one embodiment, graphite is included in the relatively homogeneous mixture of the electrode 12. Graphite decreases the porosity of the electrode, contributes to electrical conductivity and acts as a binder for the solid electrolyte composition. Graphite is preferably used as a powder. In one embodiment, the graphite powder is about 5 μm in size.

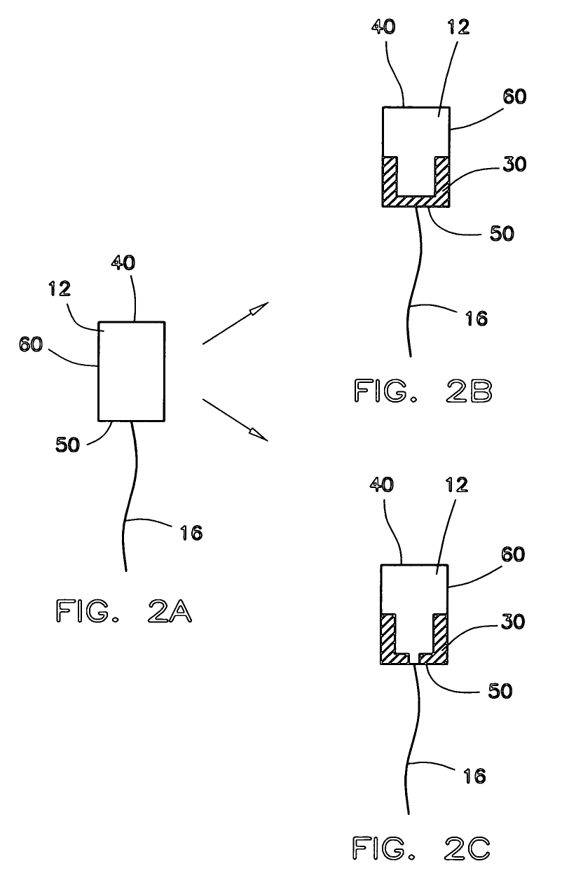

As best seen in FIG. 2B, the electrode 12 includes an integral sealing surface 30 electrolytically formed on the surface of the pellet. In particular, the integral sealing surface is formed on the second face 50 and the portion of the sidewall 60 adjacent to the second face. The integral sealing surface 30 provides an improved bonding surface for the adhesive 14 (see FIG. 1), allowing the adhesive to form strong chemical and mechanical bonds with the integral sealing surface 30 of the electrode 12. FIG. 2A shows the electrode before the integral sealing surface is formed. The formation of the integral sealing surface 30 on the electrode 12 as represented in FIGS. 2A and 2B is explained in further detail below. In one embodiment, the integral sealing surface extends along the outside periphery of the pellet starting from the plane containing the second face 50 to about 75% of the distance to the first face 40 along the sidewall 60. In other embodiments, the integral sealing surface extends less than 75% of the distance starting from second face toward the first face on the sidewall. In yet another alternative embodiment, as shown in FIG. 2C, the integral sealing surface is formed on the sidewall 60 and only a portion of the second face 50.

In one embodiment, the electrode's 12 solid electrolyte composition is silver chloride, and the integral sealing surface 30 is a silver surface. The silver surface is formed by cathodic reduction of the silver chloride compound on the cylindrical sidewall 60 and the second face 50 or a portion of the second face of the pellet 12. This electrolytically formed silver surface is capable of forming strong mechanical and chemical bonds with an epoxy used to secure the electrode 12 in the head portion 22 of the housing 20. The bonds formed between the epoxy and the integral sealing surface strongly secure the electrode to the housing and substantially prevent liquid transport between adhesive/electrode interface.

Manufacture of a silver chloride ion selective electrode assembly begins with formation of the electrode pellet 12. In order to form the electrode pellet, a pre-determined amount of the homogeneous mixture composition (e.g., silver chloride and PVC) is dispersed into a die mold. After the composition is placed in the die, the electrical conductor 16 is inserted half-way into the mold. The electrode pellet 12 is formed by pressing the mixture under a pressure of 42,000 to 45,000 psi. The dimensions of the pellet are approximately 5 mm in diameter and 5 mm in length. This portion of the manufacturing process is represented by step 110 in FIG. 5.

After the pellet is formed, manufacture of the assembly involves electrolytic formation of the integral sealing surface on the silver chloride electrode. However, before forming the integral sealing surface, the sliver chloride pellet must be prepared for electrolysis. In particular, the first face 40 of the pellet is masked to prevent any chemical reactions from occurring on the first face during electrolysis (represented in step 120 of FIG. 5). A portion of the sidewall 60 may also be masked, especially the portion of the sidewall immediately adjacent to the first face 40. Masking may be accomplished by any of numerous means, as will be recognized by those of ordinary skill in the art. For example, masking may be accomplished using tape, a jacket, or a removable coating, as will be recognized by those of ordinary skill in the art. Furthermore, in one embodiment, a portion of the second face 50 is also masked. Masking of the second face occurs around the location where the wire 16 emerges from the second face. To this end, a circular masking device, such as a silicone rubber cork, may be fed down the wire and pressed into intimate contact with the second face of the pellet. Intimate contact of the masks and/or masking device(s) with the pellet prevents access of the electrolytic solution to the masked areas.

Following masking, the pellet 12 is ready to serve as the cathode during electrolysis. A counter electrode is provided to serve as the anode during electrolysis. The counter electrode anode may be comprised of a number of compositions, such as a noble metal like platinum, gold, palladium or rhodium, vitreous carbon or amorphous carbon or a reference electrode such as silver/silver chloride or mercury/mercurous chloride (calomel), as will be recognized by those of ordinary skill in the art. The pellet 12 and counter electrode are both placed in an electrolyte solution (represented by step 130 of FIG. 5). The electrolyte solution may be potassium chloride or other suitable electrolyte solution such as, for example, potassium nitrate, potassium sulfate, sodium nitrate, sodium sulfate, tetraethylammonium perchlorate or other supporting electrolyte solutions, as will be recognized to those of ordinary skill in the art. A direct current source is then connected between the pellet 12 and the counter electrode. The wire 16 already extending from the pellet is used in making this connection. As the DC current source supplies current flow between the cathode and the anode, chemical reactions occur on the surfaces of the cathode and anode (represented by step 130 of FIG. 5). In particular, a metallic silver material is deposited on the unmasked surface of the cathode. This metallic silver material provides the integral sealing surface for the electrode when it is placed in the housing of the electrode assembly. This electrolytic formation of an integral sealing surface on the electrode is represented in the transformation of the electrode as shown between steps 2A and 2B. An alternative embodiment of the invention where a portion of the second face is also masked is represented in the transformation of the electrode as shown between steps 2A and 2C.

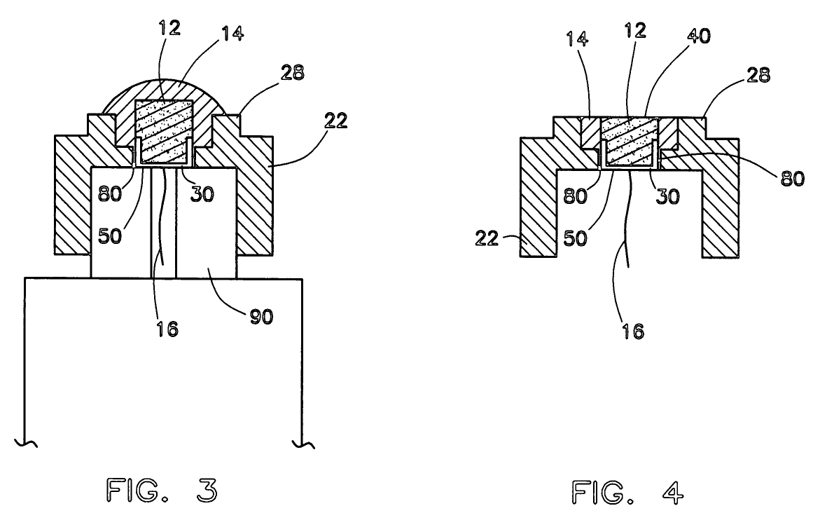

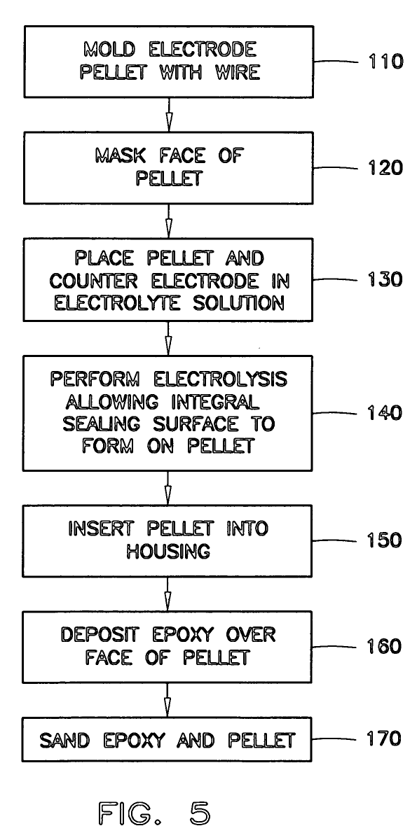

Following formation of the integral sealing surface 30 on the pellet 12, the pellet 12 is inserted into the center bore 26 of the head portion 22 such that the first face 12 extends slightly past the rim 28 of the head portion (represented by step 150 of FIG. 5). As shown in FIG. 3, the head portion and pellet are then placed on a mandrel 90 and an epoxy 14 is deposited over the pellet such that the epoxy fills the countersink area of the head portion (represented by step 160 of FIG. 5). The epoxy is sufficiently viscous to flow into the crevice 80 between the pellet 12 and head portion 22. Alternatively, the epoxy may be directly applied to the housing and pellet. The consistency of the epoxy allows it to form a rounded bead over the pellet. After the epoxy cures, the epoxy and pellet are machined down to form a flat surface that is level with the edge of the rim 28 of the head portion 22, as shown in FIG. 4. Accordingly, a smooth first face 40 is provided on the electrode 12 which is exposed to the exterior of the housing 20. The exposing of a clean first face 40 of the electrode is preferably done by sanding (represented by step 170 of FIG. 5). 600 grit sandpaper may be used to sand the pellet to a desirable surface. In one embodiment, the electrode 12 can be coated with a layer of silicone grease or vacuum impregnated with silicone oil to prevent liquid transport through the housing/electrode interface during use.

Manufacture of the ion selective electrode assembly continues as the elongated cylindrical tube 24 is inserted into the head portion 22. Epoxy is provided at the interface between the head portion 22 and elongated tube 24 to secure the head portion to the tube. The connector cable 24 which leads to a reference source is sealed to the end of the tube using an epoxy.

In an alternative method of manufacture of the ion selective electrode assembly, a hybrid electrode pellet is formed using both a standard electrolyte composition mixture with PVC or other suitable polymeric binding agent and a standard electrolyte composition mixture without a polymeric binding agent. The electrolyte composition mixture with the polymeric binding agent is used on the end of the pellet that includes the first face. The electrolyte composition mixture without the polymeric binding agent is used on the opposite end of the pellet that includes the second face and the electrical conductor. In one embodiment, a hybrid electrode pellet is produced that includes about 75% of an electrolyte composition mixture including silver chloride, PVC and carbon and about 25% of an electrolyte composition mixture that includes silver chloride and carbon with no PVC. In the case of such a hybrid pellet, the mixture without PVC provides for good production of a continuous band of silver on the sidewall/periphery of the pellet during electrolysis. Silver may also be produced on at least a portion of the second face of the pellet during electrolysis. At the same time, the hybrid pellet isolates the silver produced during electrolysis from the first face of the pellet, especially with proper masking of the pellet before electrolysis, as silver production on the exposed first face of the pellet may reduce the sensitivity of the ion selective electrode and/or cause the electrode to function as an oxidation-reduction potential (ORP) sensor.

In operation, the electrode of the electrode assembly described above is immersed into a sample solution of unknown ion concentration. A standard reference electrode is also placed in contact with the sample solution. The voltage of the electrode device can be measured with respect to the external reference electrode. For example, both the electrode device and the reference electrode can be connected electrically to a reference source such as a potentiometer or voltmeter, to display the voltage or potential difference in millivolts (mV) or concentration units of the ion being measured. The integral sealing surface of the electrode provides a strong bond between the adhesive and the electrode, thereby helping to prevent liquid transport into the interior of the housing and general electrode failure.

### EXAMPLE

Twenty-one silver chloride pellets were tested using standard procedures for securing the pellets in the housing head without the use of an electrolytically formed sealing surface. After the pellets were epoxied to the housing, they were allowed to cure at room temperature according to manufacturer's requirements. Then, each pellet was tested for the amount of force required to dislodge the pellet from its initial mounted position by the application of an axial force provided by a screw mechanism applied to the face of the pellet. The applied force was measured by an axially mounted pounds force gauge. The amounts required to dislodge the pellets from their initial position ranged from 10.6 to 25.4 lbs.

Following this, six typical sensing pellets comprised of the nominal silver chloride pellet composition were subjected to cathodic electrolysis in a potassium chloride solution at a current of 125 milliamperes from an external direct current power supply against a silver/silver chloride counter electrode functioning as an anode. The electrolysis was conducted for approximately one minute and resulted in a metallic silver deposit on the periphery and bottom of the sensing pellets. The face of each pellet was protected from silver production by isolation of the face from contact with the electrolyte solution by using a piece of masking tape on the face of each pellet. At the conclusion of the preparation of the integral bonding surfaces, three pellets thus prepared were epoxied with a typical epoxy and three were epoxied with an experimental epoxy material. There was no roughening of the pellet surface or housing. Pellet displacement testing was then conducted as described in the preceding paragraph to determine the pounds force load required to cause movement of the pellet in response to the applied load. The amounts required to dislodge the pellets from their initial position ranged from 95 to 130 lbs. This testing establishes that the electrolytically formed integral sealing surface was effective in establishing an adequate surface where durable chemical/mechanical bonds were formed.

Although the present invention has been described with respect to certain preferred embodiments, it will be appreciated by those of skill in the art that other implementations and adaptations are possible. Moreover, there are advantages to individual advancements described herein that may be obtained without incorporating other aspects described above. Therefore, the spirit and scope of the appended claims should not be limited to the description of the embodiments contained herein.

What is claimed is:

1. A method of attaching a sensor to a housing comprising:
a) forming an integral sealing surface on a sensor by subjecting the sensor to electrolysis using an electrolyte solution; and
b) attaching the sensor to the housing using an adhesive, wherein the adhesive is provided between the housing and the integral sealing surface of the sensor.

2. The method of claim 1 wherein the sensor is an ion selective electrode.

3. The method of claim 2 wherein the adhesive is an epoxy.

4. The method of claim 2 wherein the ion selective electrode is a solid pellet of compressed uniform polycrystalline material.

5. The method of claim 2 wherein the ion selective electrode comprises silver chloride.

6. The method of claim 5 wherein the integral sealing surface is comprised of metallic silver following electrolysis.

7. The method of claim 2 wherein the electrolyte solution is a potassium chloride solution.

8. The method of claim 2 wherein the ion selective electrode is a pellet having a first face and a second face, and a wire extends through the second face and into the pellet.

9. The method of claim 8 further comprising the step of masking the first face of the pellet before the step of subjecting the ion selective electrode to electrolysis in order to isolate the first face of the pellet from contact with the electrolyte solution.

10. The method of claim 9 further comprising the step of masking a portion of the second face of the pellet before the step of subjecting the ion selective electrode to electrolysis in order to isolate the portion of the second face from contact with the electrolyte solution.

11. The method of claim 2 wherein the adhesive forms chemical and mechanical bonds with the integral sealing surface.

12. The method of claim 2 further comprising the step of impregnating the ion selective electrode and the adhesive with silicone oil.

13. An electrode assembly comprising:
a) an ion selective electrode including a first face, a second face, and at least one sidewall;
b) an electrolytically formed integral sealing surface located on the ion selective electrode;
c) a housing including a seat for receiving the ion selective electrode and integral sealing surface; and
d) an adhesive positioned between the integral sealing surface and the housing.

14. The electrode assembly of claim 13 wherein the ion selective electrode comprises an insoluble metal salt.

15. The electrode assembly of claim 14 wherein the metal salt is silver chloride.

16. The electrode assembly of claim 14 wherein the electrolytically formed integral sealing surface comprises the metal of the metal salt.

17. The electrode assembly of claim 14 wherein the ion selective electrode further comprises a polymeric binding agent.

18. The electrode assembly of claim 17 wherein the polymeric binding agent is PVC.

19. The electrode assembly of claim 13 wherein the adhesive is an epoxy.

20. The electrode assembly of claim 13 wherein the integral sealing surface is located on the at least one sidewall of the ion selective electrode.

21. The electrode assembly of claim 13 wherein the seat of the housing receives the ion selective electrode such that the first face of the ion selective electrode is exposed to an exterior of the housing and the second face of the ion selective electrode is exposed to an interior of the housing.

22. The electrode assembly of claim 21 wherein the seat of the housing comprises a substantially cylindrical passage and the at least one sidewall of the ion selective electrode is connected to the substantially cylindrical passage by the adhesive.

23. The electrode assembly of claim 13 wherein an electrical conductor is connected to the ion selective electrode.

24. The electrode assembly of claim 13 where the housing is provided as part of an electrolyte analyzer.

25. A method of manufacturing an electrode assembly including a housing, an ion selective electrode having a first side and a second side, and an electrical conductor extending from the second side of the ion selective electrode, the method comprising:
a) providing an electrolyte solution;
b) immersing at least a portion of the ion selective electrode in the electrolyte solution;
c) providing a current through the electrical conductor when the ion selective electrode is immersed in the electrolyte solution in order to form an integral sealing surface on the ion selective electrode;
d) inserting the ion selective electrode along with the integral sealing surface into the housing such that the first side of the ion selective electrode is exposed to an exterior of the housing; and
e) applying an epoxy between the integral sealing surface of the ion selective electrode and the housing.

26. The method of claim 25 wherein the step of applying the epoxy includes applying the epoxy on the first side of the ion selective electrode and machining the epoxy and first side of the ion selective electrode to expose the ion selective electrode to the outside of the housing.

27. The method of claim 25 further comprising the step of covering the first side of the ion selective electrode before the step of immersing at least a portion of the ion selective electrode in the electrolyte solution.

28. The method of claim 27 further comprising the step of covering a portion of the second side of the ion selective electrode before the step of immersing at least a portion of the ion selective electrode in the electrolyte solution.

29. An electrolyte analyzer comprising:
a) an ion selective electrode assembly including
i) an ion selective electrode;
ii) an electrolytically formed integral sealing surface located on ion selective electrode;
iii) a housing including a seat for receiving the ion selective electrode; and
iv) an adhesive positioned between the integral sealing surface and the housing; and
b) a reference electrode electrically connected to the ion selective electrode.

30. A method of using an ion selective electrode comprising:
a) providing an ion selective electrode mounted in a housing with an adhesive, the ion selective electrode including an electrolytically formed integral sealing surface and the adhesive positioned between the integral sealing surface and the housing;
b) contacting the ion selective electrode with a test solution;
c) measuring the voltage of the ion selective electrode with respect to a reference electrode.
